(19) United States
(12) Patent Application Publication
(10) Pub. No.: US 2011/0099016 A1
(43) Pub. Date: Apr. 28, 2011

(54) Multi-Tenant Self-Service VXML Portal

(75) Inventors: Leo Chiu, South San Francisco, CA (US); Peter Nicholas Loukianoff, Oakland, CA (US)

(73) Assignee: Apptera, Inc., San Bruno, CA (US)

(21) Appl. No.: 12/892,655

(22) Filed: Sep. 28, 2010

Related U.S. Application Data
(63) Continuation of application No. 11/072,062, filed on Mar. 3, 2005, now abandoned.
Application No. 11/072,062 is a continuation-in-part of application No. 11/059,970, filed on Feb. 16, 2005, now abandoned.
Application No. 11/059,970 is a continuation-in-part of application No. 10/803,851, filed on Mar. 17, 2004, now Pat. No. 7,609,829.
(60) Provisional application No. 60/651,603, filed on Feb. 9, 2005.
(60) Provisional application No. 60/652,161, filed on Feb. 10, 2005.
(60) Provisional application No. 60/619,295, filed on Oct. 14, 2004.
(60) Provisional application No. 60/581,924, filed on Jun. 21, 2004.
(60) Provisional application No. 60/523,042, filed on Nov. 17, 2003.

(51) Int. Cl. G10L 15/00

(52) U.S. Cl. 704/270; 704/E15.001

(57) ABSTRACT

A multi-tenant voice extensible markup language (VXML) voice system includes a voice portal connected to at least one telephony network; a voice application server integrated with the voice portal; and a multi-tenant configuration application integrated with the voice application server, the configuration application accessible to the tenants from a data packet network.

### CROSS-REFERENCE TO RELATED DOCUMENTS

The present application is a Continuation of co-pending U.S. patent application Ser. No. 11/072,062, filed on Mar. 3, 2005, the disclosure of which is incorporated by reference herein. That application claims priority to U.S. Provisional Application Ser. No. 60/651,603, filed on Feb. 9, 2005. That application also claims priority to U.S. Provisional Application Ser. No. 60/652,161, filed on Feb. 10, 2005. That application also claims priority as a CIP to U.S. non-provisional patent application Ser. No. 11/059,970, filed on Feb. 16, 2005 which claims priority to provisional application Ser. No. 60/619,295, filed Oct. 14, 2004; further claims priority to U.S. provisional patent application Ser. No. 60/581,924, filed on Jun. 21, 2004; and further claims priority as a CIP to U.S. non-provisional patent application Ser. No. 10/803,851, filed on Mar. 17, 2004 which claimed priority to provisional application Ser. No. 60/523,042 filed Nov. 17, 2003.

### FIELD OF THE INVENTION

The present invention is in the area of voice application software systems and pertains particularly to methods and apparatus for providing an automated voice portal and VXML service for multiple tenants sharing core voice application architectures.

### BACKGROUND OF THE INVENTION

A speech application is one of the most challenging applications to develop, deploy and maintain in a communications (typically telephony) environment. Expertise required for developing and deploying a viable application includes expertise in computer telephony integration (CTI) hardware and software, voice recognition software, text-to-speech software, and speech application logic.

With the relatively recent advent of voice extensive markup language (VXML) the expertise required to develop a speech solution has been reduced somewhat. VXML is a language that enables a software developer to focus on the application logic of the voice application without being required to configuring underlying telephony components. Typically, the developed voice application is run on a VXML interpreter that resides on and executes on the associated telephony system to deliver the solution.

A typical architecture of a VXML-compliant telephony system comprises a voice application server and a VXML-compliant telephony server. To develop and deploy a typical VXML voice application, an application database is created or an existing one is modified to support VXML. Application logic is provided and is designed in terms of workflow and is adapted to handle the routing operations of the delivery system. A VXML rendering engine is provided and adapted to render VXML pages, which are results of functioning application logic. These pages, which are used as input for voice synthesis, are rendered according to a specific generation sequence or call flow.

A VXML-enabled voice portal, which may be a telephony server, is adapted to enable retrieval of VXML pages from the VXML rendering engine. A VXML interpreter, a voice recognition text-to-speech engine, and the telephony hardware/software are combined to provide voice interface function. In prior art, the telephony hardware/software along with the VXML interpreter are packaged as an off-the-shelf IVR-enabling technology. Arguably the most important feature, however, of a VXML system is the voice application server. Voice application logic is typically written in a programming language such as Java and packaged as an enterprise Java Bean archive. The application presentation logic required is handled by the VXML rendering engine 111 and is typically written in JSP or PERL.

The inventor is aware of a VXML-enabled voice application development and deployment system, referenced herein in the cross-reference section as 8109, that is adapted for economic development and deployment of voice applications. The system uses a voice application server for creating and serving voice applications to clients over a communication network. The applications are executed from a voice portal node having access to a communication network. The voice application server is capable of inferring one or more client needs based on client data including input data.

The voice application server includes an inference engine executable from the application server. The inference engine is called during one or more predetermined points of an ongoing voice interaction with a voice application and determines whether an inference of client need can be made based on analysis of existing data related to the interaction during a pre-determined point in an active call flow of the served voice application. If an inference is warranted, the engine pre-orders an inference dialog and directs the voice application to serve the dialog in the call flow instead of the normally served dialog.

The inventor also knows of a VXML server, disclosed by reference in co-pending application 8109 that can take client behavior attributes into consideration and use those attributes to select appropriate dialogs from a pool of dialogs that will better serve the customer according to the perceived behavioral state of the caller detected through interaction. In some cases the system is adapted for maintaining and consulting interaction history attributes and results experienced with that customer to determine if an inference is warranted.

VXML response flexibility has also been extended to the realm of advertising in certain systems known to the inventor, one of which is listed in the cross-reference section of this specification as case 8119. For example, a system is known to the inventor that is capable of selecting an advertisement from a pool of advertisements and for causing the selected advertisement to be utilized by a voice application for presentation to a caller during an automated voice interactive session. The system monitors the voice interaction between a caller and the voice application and selects an appropriate ad, serving at least identification and location of the ad to be retrieved and presented to the caller via the voice application. In preferred application, the server accepts and analyses data about the caller comparing the results against at least one rule. The resulting value provides reference to the advertisement selected. In this system the ads may be third-party ads that may be inserted into the running voice application flow and thus heard by the caller.

Further to the above, a system referenced herein in the cross-reference section as 8122, is also known to the inventor that is capable of leveraging an existing Web service to provide access to back-end data information or information system data, normally provided to Web users, to telephone callers. This system includes a first network service node for hosting the Web service, an information database accessible from the service node, a voice terminal connected to the first service node, and a service adaptor for integrating a voice application executable from the voice terminal to the Web service. In a preferred aspect, the service adaptor subscribes to data published by the Web service and creates code and functional modules based on that data and uses the created components to facilitate creation of a voice application or to update an existing voice application to provide access to and leverage of the Web service to telephone callers.

The above-described systems can be combined into one system that is enhanced with all of the above-mentioned capabilities. The prevailing goal in development of such enhancements and capabilities known to the inventor is to streamline development and deployment operations and to enable more efficient and accurate service to clients of enterprises leveraging the voice solutions.

In that regard, it has occurred to the inventors that multiple enterprises offering products and services often have very similar approaches to offering those products and services. In other words, the workflows and even core semantics used by these different organizations may be somewhat standardized. Examples include enterprises offering consumer goods, or those providing wireless communication services. Often the language used in promoting these goods or services is similar because of standardization of marketing approaches of industries and among competing enterprises of those industries. These similarities are prevalent in both Web services used to facilitate ordering products and services, as well as in automated telephony programs designed to facilitate product or service ordering.

However, there is no current vehicle for exploiting those standard semantics and processes that may be conveniently harnessed by an enterprise when considering VXML solutions as part of their product sales and service regimens. Each different enterprise typically invests in their own voice interaction solutions that typically involve purchase of a software package and, in many cases, lease or purchase of supporting hardware. While some software packages available off the shelf incorporate many core functionalities, which may be modified by the enterprise to incorporate their methods, products and services, much configuration and testing is required to obtain a workable solution and much of the software components purchased may not be required and therefore are not useful to the enterprise.

What is therefore clearly needed in the art is a VXML hosting service and software platform that can provide flexible voice application solutions for multiple-tenant using a common core set of voice application templates and extensions. A system such as this would provide detailed and accurate voice application solutions for enterprise use while reducing investment of time and resource of those enterprises using the service.

### SUMMARY OF THE INVENTION

A multi-tenant voice extensible markup language (VXML) voice system is provided. The system includes a voice portal connected to at least one telephony network; a voice application server integrated with the voice portal; and a multi-tenant configuration application integrated with the voice application server, the configuration application accessible to the tenants from a data packet network.

In one embodiment, the multi-tenant configuration application includes one or more electronic computer displayable interfaces enabling tenants to create and modify tenant-specific versions of one or more voice applications using common voice application architecture generically available to all of the tenants. In one embodiment, the tenants are enterprises and the multi-tenant configuration application is accessible to one or more agents of the respective enterprises, accessibility subject to secure login procedure. In one embodiment, the data packet network is the Internet network and the at least one telephony network includes a PSTN network and a wireless network.

In a preferred embodiment, the system further includes at least one tenant-specific voice application container from within which at least one tenant-specific version of a voice application is executable in the form of one or more instances by trigger event equated to identification of customers of the tenant and connected to the system for interaction. In one embodiment, the system includes a telephony gateway connected to the voice portal, the gateway adapted to receive both wireless and switched telephone calls. Also in one embodiment, the system includes a local data-storage facility within which tenant-specific voice application objects and configurations created by tenants are stored for access, storage space allotted to each tenant in a compartmental fashion. In this embodiment, voice application objects include one or more of dialog objects, audio sound objects, and connector objects to tenant-specific data resources. In a preferred application of the last-mentioned embodiment, the connector objects are adaptors providing voice application server access to identified back end data systems.

According to another aspect of the present invention, a tenant-specific voice application container module executable from a voice portal integrated with a multi-tenant VXML voice application server is provided and includes a tenant-specific greeting dialog; a tenant-specific version of a voice application; and a voice application adaptor to a tenant-specific remote data source. In one aspect, the tenant is an enterprise and the voice application container module is executable according to identification of one or more customers of the enterprise that are connected to the voice portal. In a preferred embodiment, the tenant-specific version of the voice application includes voice application logic generically available to all tenants, and voice application functional objects created by the tenant. In one aspect, customer identification to a specific enterprise is determined through telephone destination number identification.

According to another aspect of the present invention a method is provided for servicing a caller connected to a multi-tenant VXML voice system. The method includes steps for (a) associating the call to a specific tenant; (b) locating the tenant-specific voice application container module; (c) executing the voice application container module located; and, (d) connecting the call to the executed voice application container module. In one aspect, in step (a), the tenant is an enterprise and the call is associated thereto by telephone destination number identification and matching to the enterprise assigned to the number. Also in one aspect, in step (a), the call arrives at the system through a telephony gateway adapted to receive both wireless calls and switched telephone calls.

In a preferred aspect, in step (b), the location criterion includes the name of the tenant and the destination number assigned to the container. Also in a preferred aspect, in step (c), the executed voice application container module includes a greeting dialog and a tenant-specific voice application based on application logic generically available to all tenants of the multi-tenant system and voice application extension objects configured over the application logic by an agent of the tenant.

In one aspect, in step (d), the executed voice application container module connected to the caller automatically plays a greeting and interacts with the caller using the tenant-specific version of the voice application including functions of remote data access and return, and dynamic dialog option selection based on heuristic analysis of aspects attributed to the caller and the callers behavior.

In still another aspect, a machine-readable storage medium containing a set of instructions for causing a machine to perform a method is provided including instruction for (a) associating an incoming call received by a multi-tenant VXML voice application service to a specific tenant of the service; (b) locating a tenant-specific voice application container module belonging to the tenant associated to the incoming call; (c) executing the voice application container module located; and, (d) connecting the call to the executed voice application container module.

### BRIEF DESCRIPTION OF THE DRAWING FIGURES

FIG. 1 is an architectural overview of a communications network including a multiple-tenant VXML service provider according to an embodiment of the present invention.

FIG. 2 is a block diagram illustrating basic components of a VXML application and multi-tenant wizard according to an embodiment of the present invention.

FIG. 3 is a block diagram illustrating components of an enterprise-specific application shell according to an embodiment of the present invention.

FIG. 4 is a block diagram illustrating components of an enterprise-specific application shell according to another embodiment of the present invention.

FIG. 5 is a process flow chart illustrating steps for accessing and interacting with an enterprise specific version of a core voice application according to an embodiment of the present invention.

FIG. 6 is a process flow chart illustrating steps for administering modifications to an enterprise-specific application shell according to an embodiment of the present invention.

### DESCRIPTION OF THE PREFERRED EMBODIMENTS

The inventors provide, according to at least one embodiment, a multi-tenancy voice solution and delivery system that enables self-service configuration and application access to transactional function and data of each of multiple voice system tenants in a compartmentalized manner. The methods and apparatus of the present invention are described in enabling detail below.

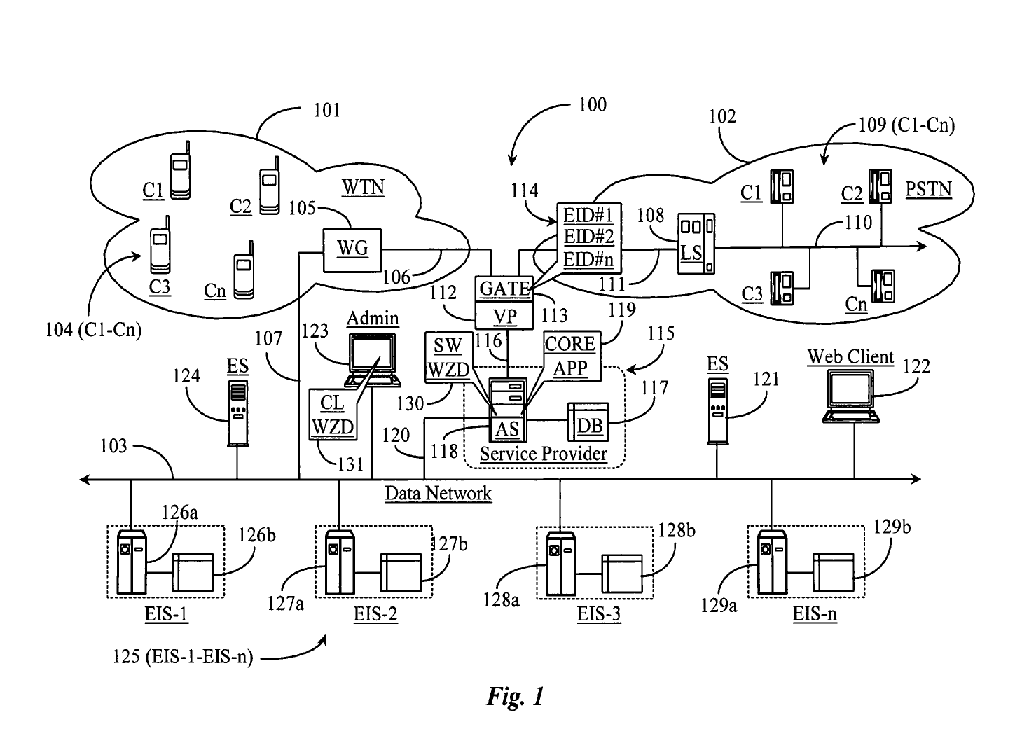

FIG. 1 is an architectural overview of a communications network 100 including a multiple-tenant VXML service provider 115 according to an embodiment of the present invention. Network 100 includes a public switched telephony network (PSTN) 102, a wireless telephony network (WTN) 101, and a data network, illustrated herein by a network backbone 103. WTN 101 may be any type of wireless access network such as a telephone cellular or satellite network. PSTN 102 may be a private telephony network instead of a public switched network. Data network 103 may be an Internet network, an Intranet network, or a corporate or private wide area network (WAN). One with skill in the art will recognize the ambiguity between the illustrated networks, which may share certain lines, data paths, and equipment. The inventor logically illustrates separate physical networks for illustrative purpose only.

A local telephony switch (LS) 108 is illustrated within PSTN 102 and may be adapted as a call distributor, a service control point, or other type of wired telephony switching equipment capable of accepting and processing telephone calls. An automated call distributor (ACD) or a private branch exchange (PBX) are possible examples of LS 108. Callers 109 (C1-Cn), illustrated herein as telephone icons, represent customers that may access services from anywhere within the PSTN network. Callers 109 have access to LS 108 via telephony cabling or wiring 110.

A wireless gateway (WG) 105 is illustrated within WTN 101 and represents a gateway routing point for connecting wireless callers 104 (C1-Cn) to services hosted on a wired network, more specifically, network 103. Callers 104 (C1-Cn) access services through gateway 105 using wireless devices such as cellular telephones or network capable devices that support both browser-based and telephony-based access.

Service provider 115 is adapted to provide voice application services to enterprises; collectively servicing their individual customers represented by callers 109 (C1-Cn) accessing services from PSTN 102 and callers 104 (C1-Cn) accessing services from WTN 101. A telephony terminal or gateway (GATE) 113 and a voice portal (VP) 112 are illustrated as a VXML compliant equipment grouping capable of receiving calls from PSTN 102 and from WTN 101, staging and identifying those received calls to specific enterprises called and providing voice interaction to service those calls according to enterprise service functions.

Terminal 113 has all of the appropriate telephony software and hardware for staging and processing calls received. Terminal 113 is accessed from PSTN 102 through switch 108 and a telephony trunk 111. Terminal 113 is accessed from WTN 101, through WG 105 and a telephony trunk 106. WG 105 also has a network access line 107 provided thereto and adapted for accessing data network 103 according to prevalent wireless access protocols, which are known in the art.

Voice portal 112 is, in a preferred embodiment, VXML enabled. VP 112 may be an integrated part of terminal 113 and is capable of interacting with callers using voice recognition and response technologies leveraging one or more VXML voice applications.

Service provider 115 has a voice application server (AS) 118 provided therein and adapted to contain and serve one or more voice applications that are adapted to be executed from and deployed to VP 112. VP 112 has direct access to AS 118 via a data network connection 116. In one embodiment VP 112, AS 118, and GATE 113 are combined in function to run on one machine. The inventor has illustrated separate components for illustrative purpose only and for clarity in describing the present invention. In this example, AS 118 has connection to network 103 via a network access line 120.

A service provider database (DB) 117 is provided within provider domain 115 and is accessible from AS 118. Database 117 may be internal to application server 118 or separate there from without departing from the spirit and scope of the present invention. Database 117 is adapted as a service repository for containing data about enterprises using the system of the present invention to service their clients. Data and functional objects specific to each enterprise are stored in DB 117 and are accessed when needed, in one embodiment, to present to callers as part of an enterprise-specific voice application that is based on core application architecture shared among multiple enterprises using the service of the present invention. Data maintained in and accessible from DB 117 may include, but is not limited to enterprise name, contact parameters, references to enterprise-maintained or hosted data, and actual or location references to enterprise-configured modules that are used contribute to voice application function on top of core application architecture.

Data network 103, which may be the Internet for example, is accessible from AS 118 using access line 120 as mentioned above. In this regard, AS 118 may access any data sources also having direct or indirect connection to network 103. A plurality of enterprise information systems (EIS) 125 (EIS-1-EIS-n) is illustrated as having connection access to data network 103. Each EIS-1 through EIS-n in this example represents an enterprise domain of an enterprise subscribing to or otherwise taking part in the system of the present invention. EIS-1 has a server 126a and a connected database 126b. EIS-2 has a server 127a and a connected database 127b. EIS-3 has a server 128a and a database 128b. EIS-n has a server 129a and a database 129b.

Each EIS domain 125 may have combined server and data storage facilities, for example, server 126a and database 126b may be combined into one machine rather than implemented as separate components. The inventor illustrates separate components for ease of description only. For each of EIS-1 through EIS-n, customers like callers 104 (C1-Cn) and callers 109 (C1-Cn) may be served data including network-accessible information and transactional results obtained through voice application interaction specific to those participating enterprises. Data stored in databases 126b-129b may include but may not be limited to product data, pricing data, service data, general information, account information, location information, and any other type of information that may be served to a customer upon request or as a result of interacting with an interface to the data systems.

An enterprise server (ES) 124 is illustrated in this example and connected to network 103 for communication. Likewise, an ES 121 is similarly illustrated as connected to network 103. ES 124 and ES 121 represent servers that may be publicly accessible and hosted on network 103. In one embodiment, servers 124 and 121 may be public contact servers wherein Web pages and other electronic interactive forms may be served to customers for the purpose of doing business with the enterprise. Servers 124 and 121 may also be enterprise-hosted data servers locatable by Internet Protocol (IP) address, the data there in locatable by universal resource indicator (URI) and or by universal resource locator (URL).

Callers 104 (C1-Cn) may through WG 105, for example, access network 103 and communicate with ES 124 or with ES 121 in order to access enterprise data maintained by any hosting enterprise EIS-1 through EIS-n. Likewise, a Web client, illustrated herein as Web client 122 may connect to network 103 through standard network access function and protocol, and then once connected may navigate to and communicate with ES 124 or ES 121 in order to do business with any hosting enterprise EIS-1 through EIS-n. Web services adapted with appropriate protocols for access by Web client 122 and for callers (104 C1-Cn) may be provided within servers 124 and 121 to facilitate data access to account data, information data, and so on.

However, callers 109 (C1-Cn) are not typically adapted for network access and therefore access services offered by enterprises through voice application interaction. In similar fashion, callers 104 (C1-Cn) may use pure telephony connection to access services through voice interaction. In this regard, service provider 115 maintains at least one core voice application architecture (CORE APP) 119 executable from VP 112. Application 119 represents a skeletal voice application architecture that is useable by multiple enterprises as a base interaction architecture or call flow over which enterprise-specific functionality and scripting may be applied to personalize the application to the enterprise and therefore to callers of that enterprise.

A software wizard (SW WZD) 130 is provided, in this example, to AS 118 and is adapted as a multiple-tenant configuration wizard. In one embodiment, wizard 130 may be executed by remote access from an administration interface such as an administration node 123 illustrated in this example as connected to network 103. In this embodiment, an administrator may use node 123 to manage and configure separate enterprises to be enabled to leverage core voice application 119 to interface with their customer base analogous to callers 109 (C1-Cn) and callers 104 (C1-Cn). In this case, an administrator of the service provider uses node 123, which may be hosted by the service providing organization to manage and oversee the application of enterprise-specific configuration over the core application to produce an enterprise-specific version of application 119 that may be interacted with by calling one or more than one specific telephone number unique to the enterprise.

In a preferred embodiment, SW WZD 130 is enhanced for multi-tenancy and is further enhanced for access and use by each individual enterprise customer of service provider 115 participating in the service of the present invention. In this embodiment, an administrator specific to an enterprise may access SW WZD 130 via a connected node like node 123, which in this embodiment, may also have a client wizard (CL WZD) 131 provided thereto and executable there from. CL WZD 131 may be adapted as an enterprise-specific configuration wizard that communicates with multi-tenant wizard 130. In this way an enterprise administrator may configure changes or modifications to an enterprise specific portion of core application 119 while off line. The administrator may then connect online and upload the changes into SW WZD 130 after providing proper credentials such as logging in to use wizard 130. In this preferred embodiment, each enterprise configures its own voice application functionality and oversight by a service provider administrator is not specifically required. It should also be noted that client wizard 131 is optionally provided for convenience and not specifically required in order to practice the present invention.

In practice of the invention according to a preferred embodiment, a specific enterprise may leverage multi-tenant wizard 130 to create and configure voice application functionality over core application architecture and to configure application access to enterprise resources. For example, EIS-1 comprising server 126a and database 126b may be hosted by a banking institution and may provide, among other services, a location service for automated transaction machines (ATMs) to callers based on callers location at the time of access or on callers input during interaction. In this example, an administrator of the bank may use node 123 and wizard 131 to connect online over network 103 and to access AS 118 and multi-tenant wizard 130. The administrator may use tools provided through the wizard to create and configure dialog objects and application functionality for interacting with customers and for accessing EIS-1 and returning the appropriate ATM locations to callers.

Service provider database 117 may have a customer space allotted to the administrator of the bank for locally storing configuration data and dialog objects required to “dress” the generic core application 119 to provide the ATM locator service. In this case, gateway 113 may have an enterprise ID number list comprising of telephone numbers provided by the enterprises to enable telephone access to their specific voice services. Enterprise identification (EID) number 1 in the list may correspond to the ATM locator service configured with service provider 115, the result data of which is accessible from EIS-1. Therefore, any customer calling a unique number like 1-800-ATM-FIND, is routed to VP 112 whereupon the enterprise-specific version of core application 119 (ATM Location Dialog) is located and executed, if not already running on server 115. Special enterprise-specific shells or skins may be provided to insure that all of the appropriate dialogs and interaction sequences are followed.

EID#2 may identify and enable access to services fulfilled through EIS-2 and EID#n may identify and enable access to services fulfilled through EIS-n. In one embodiment, an enterprise may have more than one service to which telephone access is desired and which may be fulfilled by different voice dialogs and one or more data source locations. To this end an enterprise may use core application architecture 119 as an underlying base for configuring more than one service.

One with skill in the art can easily differentiate between a standard voice-based system telephone service such as a voice mail service configurable by multiple customers and the system of the present invention, which provides a robust, VXML-enhanced enterprise voice application architecture over-which personalized voice application functionality including transactional functionality and interaction ability to access system-remote data sources can be built and leveraged in a manner that securely separates the participating enterprises relating to the system with respect to customers accessing the system and with respect to data provided those customers by the participating enterprises.

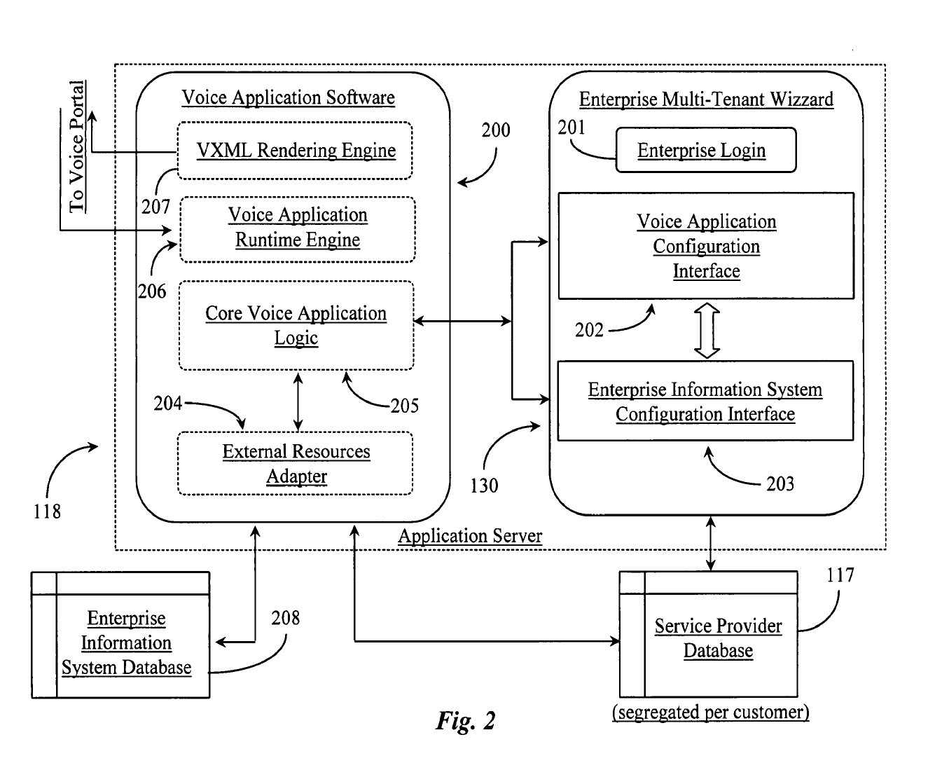

FIG. 2 is a block diagram illustrating basic components of VXML application server 118 including multi-tenant wizard 130 according to an embodiment of the present invention. Voice application server 118 includes basic voice application software 200. Software 200 includes core voice application logic 205, which in this embodiment, is adapted as a skeletal voice application architecture and functionality that may be shared by multiple enterprises using the system of the present invention. Application logic 205 is analogous to CORE APP 119 described above with reference to FIG. 1. It contains the basic call flows and synthesized dialogs and options that may be generic to the multiple enterprises.

An external resources adaptor 204 is included within voice application software 200. Adaptor 204 provides server access to external systems and data stores. In this case, application server 118 has access to service provider database 117, which is segregated for the purpose of providing each subscribing enterprise with a secure memory allotment for storing data about the enterprise and for storing enterprise voice application configuration data and objects used in voice interaction with their customers. Application server 118 also has access to EIS databases 208, which are analogous to databases 126b through 129b described further above. EIS databases 208 contain the back end data that is tapped b server 118 to provide system response data to calling customers per the enterprise version of the voice application logic 205 that customers are interacting with.

Adaptor 204 may enable access to other external data resources hosted by enterprises such as Web server-based data and publicly accessible information systems. In one enhanced embodiment, adaptor 204 includes adaptor components that enable server 118 to access and leverage existing enterprise Web services designed for browser-based access as described with reference to co-pending application 8122. In this case, an enterprise portion of core application 205 encompasses a functional voice-based dialog tree that leverages some existing Web service of the enterprise and returns results to callers via voice synthesis.

Software 200 includes a voice application runtime engine 206 that manages and monitors the run state of instances of voice applications active in the system. A VXML rendering engine 207 is included within software 200 and is adapted for rendering VXML to a voice portal for interpretation using TTS technology and synthesis to speech for presentation to interacting callers. Software 200 represents only the active voice application components in this example.

Other server components like voice application development software may also be present. Further, adaptor 204, application logic 205, and runtime engine 206 have sub-components provided thereto such as may be required to enable function according to various possible features known to the inventor that may be used to enhance caller and enterprise experience in interaction through a voice application. For example, adaptor 204 may include a resource manager, a reporting manager, an event queue, a connector to Web-based resources, and the like. Voice application runtime engine 206 may include unique components known to the inventor such as a behavioral adaptation engine; a client needs inference engine; and a dynamic grammar generator. Runtime engine 206 may also include sub-components like a dialog controller, dynamic dialog selector, and a rules manager. For the purpose of clarity of description, only the basic components required to enable the present invention are illustrated here. Further detail about additional components described above is available through specifications listed in the cross-reference section of this specification including those servers described with reference to co-pending application 8109.

Multi-tenant wizard 130 is provided within application server 118 and adapted as previously described, to provide access to core application logic and the tools to create and configure enterprise-specific functionality to the core application logic in order to produce a voice application that is specific to the enterprise and to callers of that enterprise such as may be received and identified to the enterprise at a connected voice portal. In this regard, wizard 130 includes an enterprise login function 201. Login function 201 may be provided to an accessing administrator in the form of a Web-interactive interface containing fields for entering credential-based information and a submission action button for submitting the information. Each enterprise subscribed to voice application services through the service provider must authenticate before gaining access to configuration tools.

Once login is achieved by an enterprise, a voice application configuration interface 202 is served enabling the administrator to see his or her current settings and enabling the administrator to change or modify the current enterprise-specific voice application version of core application 205. Through this interface, the administrator may provide dialog objects in XML format or, in some cases, as pre-recorded media objects. Voice application interface 202 has access to basic core voice application architecture 205. Core logic 205 may include one or more generic dialog trees including optional dialog trees that may be selected and used as base architecture for enterprise functionality without requiring incorporation of all of the logic that may be available.

The enterprise administrator may create objects and plug those objects into available “slots” in the core architecture in order to “personalize” a call flow to the enterprise. For example, the core application logic 205 may provide for more than on generic customer greeting dialogs, which may be different from each other. An administrator may select one that best suits the enterprise and then personalize that dialog flow by inserting or associating the correct enterprise-specific objects to be included in the flow. These may include the enterprise name, slogan, and any enterprise options that may be plugged into available option slots. An example of a core greeting dialog with open slots might be “Welcome to ______.” “Please say one of the following options to continue”, “______, ______, ______.” The administrator provides the objects that may plug into those slots like a name of a bank for the first slot and “savings”, “checking” and “recent transactions” for the remaining option slots of the dialog. The enterprise thus personalizes a voice application to be executed only for callers to that enterprise as may be identified by destination number, through pre-interactive voice response screening, or through other common caller ID methods.

An enterprise information system configuration interface 203 is also provided as part of multi-tenant wizard 130. Interface 203 provided the tools to link back-end data or remote data services to the appropriate function slots provided in voice application architecture. The wizard provides access to plug-in objects that may be easily defined and extended to enable access to the data that the enterprise authorizes to be returned to customers. In one embodiment, a completed enterprise-specific version of a voice application may be stored locally in service provider database 117 for access when any caller to that enterprise is detected. In one embodiment, only the appropriate enterprise objects are stored in provider database 117 and those objects are accessed in real time as needed when the selected core application tree is running on behalf of the enterprise.

An enterprise administrator may, as previously described above, access wizard 130 through a client application or wizard analogous to wizard 131 described further above. In this case, an administrator may login to wizard 130 and obtain the appropriate configuration tools core component description and instruction. The administrator may log off and configure the enterprises functionality off line and then reconnect to upload the configuration. Likewise, once a configuration is successfully implemented, the administrator may save a copy of the configuration in the local or personal wizard. In addition, if a login is required in the personal wizard, the same login may also be applicable to the multi-tenant wizard.

Once an enterprise-specific voice application is configured it may be located and executed within application server 118 whenever a caller identified as a customer of the enterprise triggers it. An enterprise may optionally receive value added services in use of its newly created voice application interface. For example, callers to the enterprise may be analyzed for mood and behavior thus enabling dynamic selection and offering of certain enterprise options, which may be maintained in a pool of options. Heuristic analysis of caller history and interaction behavior may enable streamlining of the enterprise portion of the application and may enable selective servicing based on statistics. In one embodiment, this may include dynamic insertion of advertising into one or more portions of the voice application call flow using ad-insertion capabilities described in co-pending application 8119. Strict and secure segregation of multiple enterprises using the system with respect to configuration access, data access, and customer association ensures that each participating enterprise has virtually its own voice application services, which may not be confused with services belonging to any other participating enterprise.

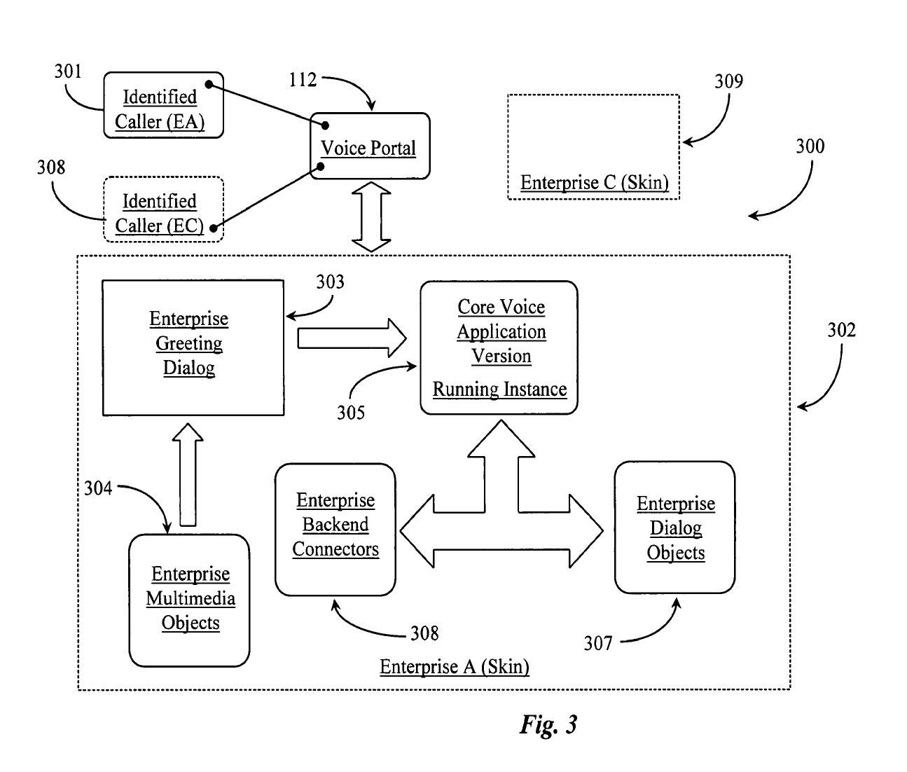

FIG. 3 is a block diagram illustrating components of an enterprise-specific application shell 302 according to an embodiment of the present invention. In this embodiment, enterprise-specific skin or shell 302 is conceived, provided, and functions as an application container specific to the enterprise and accessible only by customers of that enterprise during active voice application interaction. In this case, shell 302 is one for an enterprise A. A caller 301 is illustrated in this example as connected to voice portal 112 for communication. In this case, caller 301 is identified by telephone number identification or by prescreening as a customer attempting to reach enterprise A.

Voice portal 112 calls server (118) and causes execution of enterprise application shell 302. Therefore, customer 301 may only connect to and interact with voice application functionality launched within shell 302. Shell 302 contains an enterprise-specific greeting dialog 303. Shell 302 also contains, in this example, enterprise-specific multimedia objects 304, which may be used by greeting 303. In this way, the enterprise may provide its own music, slogans, or other audio to play at suitable times during voice application interaction.

Shell 302 contains an executed instance of core voice application 305 dressed with enterprise dialog objects 307 and enterprise backend connector objects 308. In this example, application 305 is an enterprise-specific version created using core logic and is already configured to use objects 307 and objects 308. Shell 303 as an executable software container, may be stored in service provider database 117 described with reference to FIG. 1 above and then accessed and executed when needed. In this embodiment, the required portion of the core application logic used as a voice application base is copied and exists separately within shell 302 and is only executable through shell 302. In this embodiment, shell 302 encompasses all of the enterprise space allotted to it in service provider database 117.

In one embodiment, greeting dialog 303 is an integrated part of application 305 and is automatically executed and begins playing when shell 302 is executed. If a caller terminates during the greeting, the shell will close unless there is another caller accessing it. Dialog 303 may also contain a login procedure to identify specific customers authorized to access personal data so that data returned to a specific customer is that customers personal data and no one else's data. In this embodiment all of the enterprise-added objects are contained within the shell and are configured, appropriately to the copied version of core application.

In one variation to the above-described example, there may be object pools contained within objects 307, which may be collectively applicable to one specific slot in the voice application dialog option flow. In this case, rules may be provided and may reside within the shell wherein such rules may be consulted by application functionality to determine which object to select and insert into the application in real time. This is useful if an enterprise, for example, serves options based on caller historical preferences, interaction behavior, or needs inference analysis. In the latter case of enhanced function, shell 302 in run state has access to all of the normal and enhanced application server features. It is noted herein that a dialog object may be a simple as a single word or it may be as complex to encompass an entire interaction sequence tree such as a transaction sequence.

As described above, in a preferred embodiment caller 301 identified as attempting to reach enterprise A can only interact through shell 302, which belongs to enterprise A. A caller 308, identified as a caller trying to reach an enterprise C, is also connected to VP 112 in this example. Once caller 308 is identified, voice portal 112 located and causes execution of a shell 309, which is specific to enterprise C. Both shells 302 and 309 may be active within the application server and connected to voice portal 112 at the same time along with many other running shells. Since each enterprise shell is a separate voice application package in this embodiment, the service is constructed around the existence of multiple executable packages, including provision of suitable memory space, computing power and number of communication ports. The hardware and communication facilities shall be sufficient to accommodate all of the enterprise running applications simultaneously and servicing a constant stream of accessing callers.

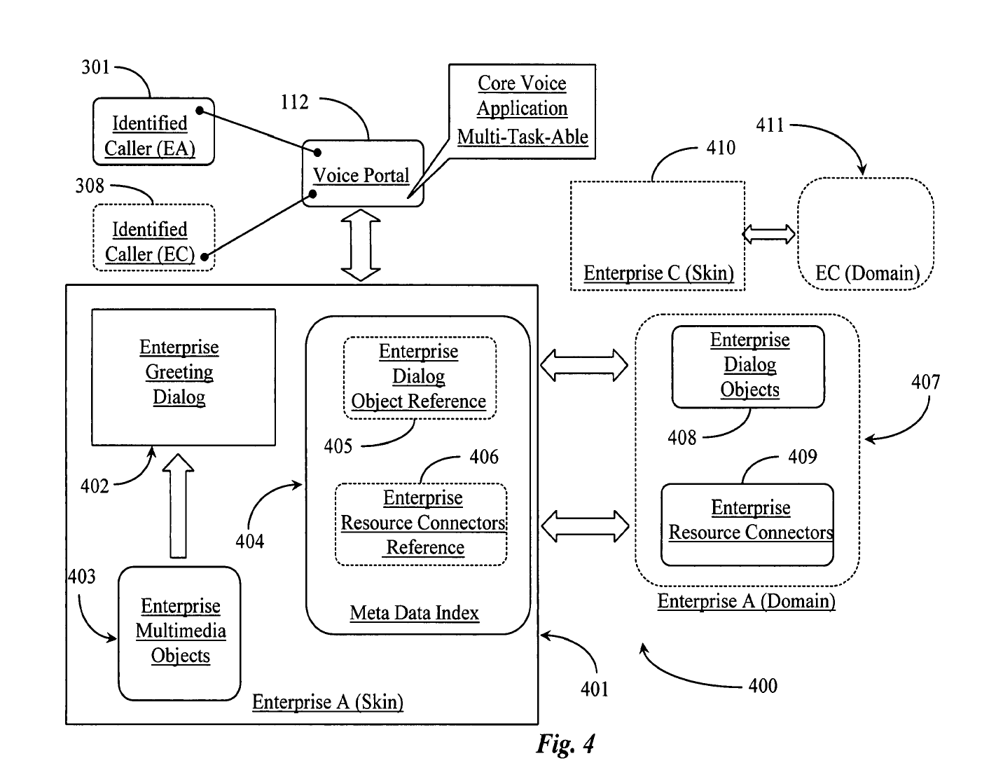

FIG. 4 is a block diagram illustrating components of an enterprise-specific application shell 401 according to another embodiment of the present invention. Shell 401 is similar to shell 302 described with reference to FIG. 3 above except that it does not contain a copied version of a core voice application. In this example, shell 401 includes an enterprise-specific greeting dialog 402. In this embodiment, enterprise greeting 402 is not an integral part of a larger enterprise-specific version of a voice application. Rather, it plays automatically when shell 401 is located and executed. Shell 401 has enterprise-specific multimedia objects 403, which are analogous to objects 304 described with reference to FIG. 3 above. Greeting 402 uses objects 403 during run state.

In this embodiment, a core voice application 400 is executed from voice portal 112 and is always running in the application server with respect to enterprise-specific shells. In this embodiment, caller 301 connects to voice portal 112. Core application 400 is in a running state. Voice portal 112 first identifies the caller to enterprise A and then locates and executes shell 401 on behalf of the caller. Greeting dialog 402 is automatically played for the caller. When the caller elects to continue past the point of the greeting, he or she joins core application 400 in association with enterprise shell 401. In this sense, application 400 operates according to shell information and retrieves the appropriate dialog objects and resource connectors as needed.

Shell 401, in this case does not actually contain any enterprise dialog or data connector objects to enterprise resources. Rather, a meta data index 404 is provided as part of enterprise shell 401 and is adapted as a resource location reference that core application 400 may use to fetch and utilize the objects as may be required. Meta data index contains a reference section 405 listing the existing enterprise-specific dialog objects and specifying where to find them. Meta data index 404 also contains a reference section 406 listing the existing resource connector objects and specifies where to find them. In this embodiment, each listed item also references or points to the places that it plugs into the core voice application. The actual objects and connectors are stored in an enterprise domain 407, which may be allotted domain space reserved in service provider database 117 described with reference to FIG. 1 above or in any other network-connected server established under the enterprise domain.

In this example, core application 400 looks ahead to meta data index 404 and uses it as instruction for fetching and installing the enterprise functionality as it is required according to the enterprise shell associated with the caller interacting with the application. Therefore, for each caller using a different enterprise shell, the experience navigating and interacting with the same voice application is different. The only core application logic that is utilized in this embodiment is that identified within the enterprise shell associated with a specific caller.

For optimized performance, the actual dialog objects and resource objects may be cached or stored locally such as in the service provider domain. A high-speed data interface is used for fast location access and service of those objects to their appropriate installation points in the voice application. As the application builds, for example, a sub dialog tree of an enterprise over which the caller will navigate and make voice selections, it maintains a bridge to the last jump-off point or menu in the core architecture so the caller may loop back to a starting point. In this way, complex dialog trees may be provided by an enterprise enabling still more flexibility for sharing a basic core application among the multiple enterprises. Moreover. Only one main application may be running and servicing clients instead of multiple created instances or versions of the application. Thus conserving system resources.

In a preferred embodiment, the service provider allows credential-based access to core application logic including object extension tools for connecting enterprise-specific objects to the main application. In this way an enterprise administrator does not have to write a lot of complex code. As with any other single tenant VXML application, the voice portal interoperates XML data rendered by the application server and converts it to speech for the caller. In some cases, an enterprise may submit actual voice files instead of text to be interpreted and synthesized.

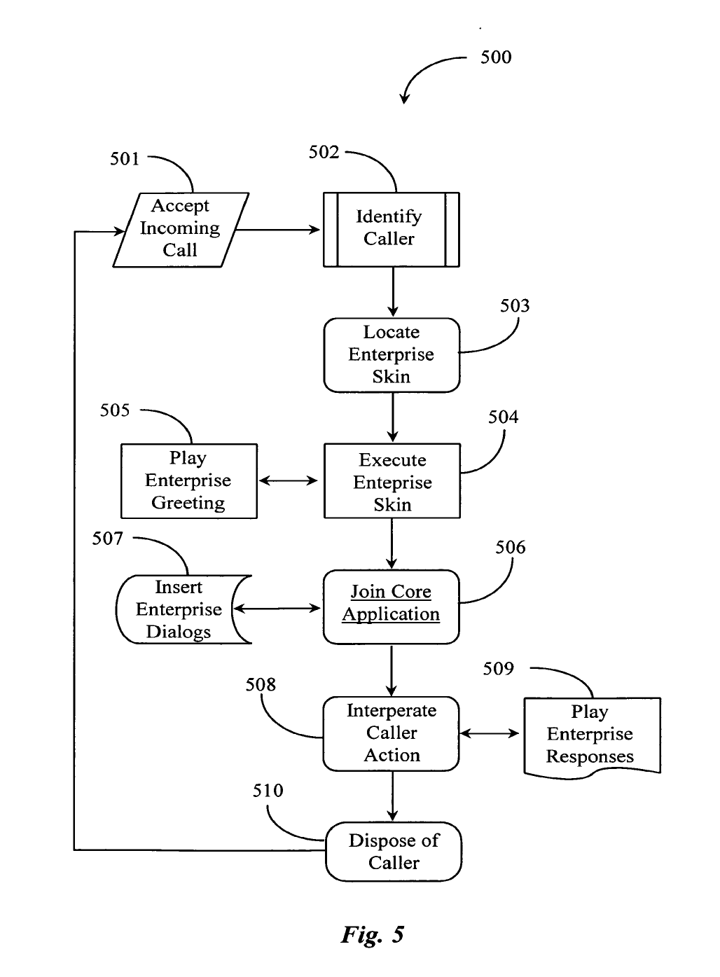

FIG. 5 is a process flow chart 500 illustrating steps for accessing and interacting with an enterprise specific version of a core voice application according to an embodiment of the present invention. At step 501, the system accepts an incoming telephone call from either a wireless carrier or a wired telephony switch. There may be one or more call waiting queues set up to sort calls. At step 502, the caller is identified through DNS, IVR, or other common methods to determine which registered enterprise the caller is attempting to interact with. At this point the call may be placed in an enterprise-specific queue if one is available.

At step 503, the voice portal locates the enterprise-specific skin. At step 504, the enterprise skin is executed if not already running. In one embodiment there may be multiple running instances of an enterprise skin. At step 505 the enterprise greeting is presented to the caller. If the caller elects to continue, the caller joins the core voice application at step 506. In this case the main application handles all callers according to instruction from each appropriate skin and according to functionality provided by each enterprise.

At step 507, the application retrieves and presents enterprise dialogs to the caller. These dialogs are enterprise specific and are defined within the enterprise skin or shell. At step 508, the system interprets caller action such as option selection and the like, which may be vocalized by the caller. In some cases, optional behavioral analysis, mood analysis, or inference analysis may be performed if an enterprise has subscribed to one or more of these enhanced services. At step 509, the application server fetches and presents system responses according to enterprise rules. At step 510, if the call has been satisfied the system may terminate the call. At step 501, the system accepts the next incoming call. It is important to note herein that multiple calls to different enterprises may be simultaneously handled by the system. The only limit to the number of calls that may be processed by the system at any point in time is determined by design and available bandwidth.

It will be apparent to one with skill in the art that there may be more steps including sub-steps included within the illustrated steps without departing from the spirit and scope of the present invention. The exact number and description thereof dependent in part upon system capabilities and architecture according to various possible embodiments. For example, in one embodiment, at step 506, the core voice application is executable as an enterprise-specific voice application instance and runs within the boundaries of the enterprise skin. Likewise, sub routines may be included for heuristic analysis of customer behavior or mood. This may be performed in real time during interaction with a voice application per customer.

Heuristic analysis may also be performed using past interaction characteristics of each caller or of a group of callers. In either case, inference points may be provided as part of an enterprise-specific call flow where upon the system compares results against a set of rules and then makes a decision whether to employ a dynamic response selection from a pool of possible responses.

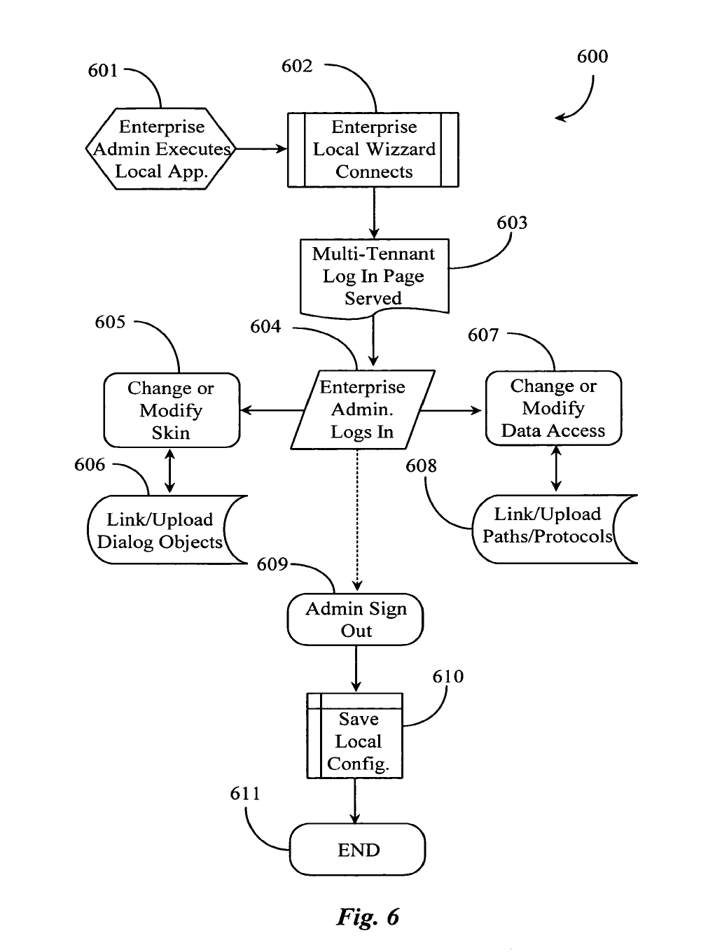

FIG. 6 is a process flow chart 600 illustrating steps for administering modifications to a enterprise-specific application shell according to an embodiment of the present invention. At step 601 an enterprise administrator executes a local client application or wizard. Step 601 is optional. In one aspect, for example, the administrator may simply navigate to a configuration interface using a browser program. If however there is a client wizard, this may enable the administrator to accomplish some configurations tasks offline.

At step 602, the enterprise local wizard of step 602 connects online to a prevailing network such as the Internet network and navigates to a multi-tenant wizard analogous to wizard 130 of FIG. 1 hosted in a voice application server analogous to server 118 of FIG. 1. At step 603, an enterprise login page is served. At step 604 the administrator provides the required log in information and logs into the system.

At step 605, the administrator may optionally change or modify the enterprise skin. At step 606, the administrator may link to and/or upload dialog objects used to enable enterprise voice application function over core application logic. At step 607, the administrator may change or modify data access to enterprise resources. This may occur if new data categories are included, data has changed locations, or certain data is no longer offered in a service. At step 608, the administrator may link and/or upload data paths and protocols used to access the appropriate data resources.

Steps 605, 606, 607, and 608 do not have to occur in any specific order or at all. The multi-tenant wizard provided tools for defining the enterprise information as XML objects, which may be installed over core application logic to provide the personalized functionality. Moreover, a series of steps for first time use of the multi-tenant wizard may be undertaking which may vary somewhat from the steps illustrated. For example, a step may be provided immediately after log in for configuring a new enterprise skin. It is noted that an enterprise administrator may configure and maintain more than one skin without departing from the spirit and scope of the present invention. Such a case might be when the enterprise offers multiple disparate services each accessible to customers through a different telephone number.

When the administrator has finished the session, he or she may save the current configuration and sign out in step 609. At step 610, if the administrator has a local client installed he may save the current configuration locally. In this way, the administrator may subsequently make modifications or changes offline using the local wizard and then connect online, log in to the multi-tenant wizard, and upload the new changes already configured. At step 611 the session terminates.

One with skill in the art will recognize that there may be more steps and sub steps included in the illustrated process flow without departing from the spirit and scope of the present invention. For example, in a case where the enterprise creates a greeting, there may be steps for selecting from generic greeting options and for applying enterprise-specific dialog and media objects to a selected option. There are many possibilities.

The method and system of the present invention may be practiced over any data packet network accessible from a telephony system and network. In one embodiment the system is hosted on an Internet network that has a gateway accessible from both wireless telephony carriers and from switched telephony carriers. Enterprise data made available to customers through the multi-tenant voice application system is not strictly limited to back end legacy data, but may also include data from other accessible data sources and information systems, some of which may not necessarily be owned by the enterprise. For example, third-party data servers may be contracted by the enterprise to provide certain data either in response to customer interaction or in response to customer profiling. One example of third-party data that may be provided through the system of the invention is advertisement data.

What is claimed is:

1. A multi-tenant voice extensible markup language (VXML) voice system comprising:
a voice portal connected to at least one telephony network;
a voice application server integrated with the voice portal; and
a multi-tenant configuration application integrated with the voice application server, the configuration application accessible to the tenants from a data packet network.
